(19) United States
(12) Patent Application Publication
(10) Pub. No.: US 2006/0107693 A1
(43) Pub. Date: May 25, 2006

(54) Method for the production of synthetic silica glass

(75) Inventors: Martin Trommer, Schluchtern (DE); Stefan Ochs, Bad Camberg (DE); Jurgen Schafer, Hausen (DE); Bodo Kuhn, Hanau/Main (DE); Bruno Uebbing, Alzenau (DE); Heinz Bauscher, Langenselbold (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmbH & Co. KG, Hanau (DE)

(21) Appl. No.: 10/543,093

(22) PCT Filed: Jan. 21, 2004
(86) PCT No.: PCT/EP04/00442

§ 371 Date: Aug. 19, 2005

(30) Foreign Application Priority Data
Jan. 24, 2003 (DE) 103 02 914.1

(51) Int. Cl. C03B 19/06

(52) U.S. Cl. 65/17.4

(57) ABSTRACT

The invention relates to a previously known method for producing synthetic silica glass, comprising the following steps: a gas stream containing a vaporizable initial substance, which can be converted into SiO₂ by means of oxidation or flame hydrolysis, is formed; the gas stream is delivered to a reaction zone in which the initial substance is converted so as to form amorphous SiO₂ particles; the amorphous SiO₂ particles are deposited on a support so as to form an SiO₂ layer; and the SiO₂ is vitrified during or following deposition of the SiO₂ particles in order to obtain the silica glass. The aim of the invention is to create an economical method for producing synthetic silica glass, which is characterized by a favorable damaging behavior towards short-wave UV radiation while being particularly suitable for producing an optical component used for transmitting high-energy ultraviolet radiation having a wavelength of 250 nm or less. Said aim is achieved by using a mixture of a monomeric silicon compound containing a singular Si atom and an oligomeric silicon compound containing several Si atoms as an initial substance, provided that the oligomeric silicon compound in the mixture contributes less than 70 percent to the total silicon content.

The present invention relates to a method for producing synthetic silica glass, comprising the steps of:
a) forming a gas stream containing a vaporizable initial substance which can be converted into SiO₂ by means of oxidation or flame hydrolysis,
b) supplying the gas stream to a reaction zone in which the initial substance is converted so as to form amorphous SiO₂ particles,
c) depositing the amorphous SiO₂ particles on a support so as to form an SiO₂ layer,
d) vitrifying the SiO₂ layer either during or following deposition of the SiO₂ particles to obtain the silica glass.

Such methods for producing synthetic silica glass by oxidation of flame hydrolysis of silicon-containing initial substances are generally known under the names VAD method (vapor phase axial deposition), OVD method (outside vapor phase deposition), MCVD method (modified chemical vapor deposition) and PCVD method (or also PECVD method; plasma enhanced chemical vapor deposition). In all of these methods, SiO₂ particles are normally produced by means of a burner and deposited in layers on a support which is moved relative to a reaction zone. At an adequately high temperature in the area of the support surface, the SiO₂ particles are vitrified immediately (“direct vitrification”). By contrast, in the so-called “soot method” the temperature is so low during deposition of the SiO₂ particles that a porous soot layer is obtained that is sintered in a separate process step to obtain transparent silica glass. Both direct vitrification and soot method yield a dense, transparent synthetic silica glass of high purity.

The support is normally removed in a subsequent process step. Quartz glass blanks are thereby obtained in the form of rods, blocks, tubes or plates which are further processed into optical components, particularly lenses, windows, filters, mask plates, for use in microlithography.

A useful initial substance for producing synthetic silica glass is silicon tetrachloride (SiCl₄). However, many other silicon-organic compounds have also been suggested from which SiO₂ can be formed by hydrolysis or oxidation. As examples of suitable initial substances and as literature, the following should here be indicated:

Monosilane (SiH₄; DE-C 38 35 208), alkoxysilanes (R₄₋ₙ Si(OH)ₙ, where R represents an alkoxy group having one to four C atoms), and nitrogen silicon compounds in the form of silazanes (EP-A 529 189). The so-called polysiloxanes (also abbreviated as “siloxanes”) form particularly interesting initial substances, and their use for producing synthetic SiO₂ is for example suggested in DE-A1 30 16 010 and in EP-B1 463 045. The substance group of the siloxanes can be subdivided into open-chain polysiloxanes (chain polysiloxanes for short) and into closed-chain polysiloxanes (cyclopolysiloxanes for short). The chain polysiloxanes are described by the following chemical formula:
R₃Si·(SiR₂O)ₙ·SiR₃
where n is an integer≧0. The cyclopolysiloxanes have the following general formula:
SiₚOₚ(R)_{2P}
where P is an integer≧2. The residue “R” is each time for example an alkyl group, preferably a methyl group.

The optical components made from the synthetic silica glass are inter alia used for transmitting high-energy ultraviolet radiation, e.g. in the form of optical fibers or as optical exposure and projection means in microlithography devices for producing large-scale integrated circuits for semiconductor chips. The exposure and projection systems of modern microlithography devices are equipped with excimer lasers that emit high-energy pulsed UV radiation of a wavelength of 248 nm (KrF laser) or of 193 nm (ArF laser).

Short-wave UV radiation of this type may produce absorption-inducing defects in optical components of synthetic silica glass. Type and extent of a defect formation depend on the type and quality of the corresponding silica glass which are substantially determined by structural properties, such as density, refractive index profile, homogeneity and chemical composition.

The influence of the chemical composition of synthetic silica glass on damage behavior upon irradiation with high-energy UV light is e.g. described in EP-A1 401 845, which also discloses a generic production method. Hence, high radiation resistance is achieved in a silica glass which is characterized by high purity, an OH content ranging from 100 wt ppm to about 1,000 wt ppm and, at the same time, by a relatively high hydrogen concentration of at least 5×10¹⁶ molecules/cm³ (based on the volume of the silica glass).

In the damage patterns described in the literature, a distinction can be made between those patterns in which an increasing absorption is observed during continuous UV irradiation (induced absorption) and those patterns in which structural defects are produced in the glass structure, such defects being e.g. manifested by fluorescence generation or by a change in the refractive index, which however need not necessarily change the radiation absorption.

In the damage patterns of the first group the induced absorption may e.g. rise linearly, or saturation is accomplished after an initial rise. Furthermore, it is observed that an initially existing absorption band will disappear within a few minutes after the UV source has been switched off, but will soon regain the former level after renewed start of the irradiation process. The last-mentioned behavior is called “rapid damage process” (RPD) in the literature. Furthermore, a damage pattern is known where structural defects evidently accumulate in the silica glass such that these manifest themselves in a sudden strong increase in absorption. The strong increase in absorption is called “SAT defect” in the literature.

In connection with the damage patterns of the second group, a known phenomenon is the so-called “compaction” which occurs during or after laser irradiation with a high energy density. This effect manifests itself in a local density increase which leads to a rise in the refractive index and thus to a deterioration of the imaging properties of the optical component. An opposite effect is observed when an optical component made of silica glass is subjected to laser radiation of a low energy density but with a high pulse number. These conditions will create so-called “decompaction”, which is accompanied by a decrease in the refractive index. Irradiation will also lead to a local density change and thus to a deterioration of the imaging properties. Compaction and decompaction are thus also defects that may limit the service life of an optical component.

It is therefore the object of the present invention to provide an economic method for producing synthetic silica glass that is characterized by a favorable damage behavior with respect to short-wave UV radiation and that is particularly suited for producing an optical component for transmitting high-energy ultraviolet radiation of a wavelength of 250 nm or less.

Starting from the above-mentioned method, this object is achieved according to the invention in that a mixture of a monomeric silicon compound containing a singular Si atom and of an oligomeric silicon compound containing several Si atoms is used as the initial substance, with the proviso that the oligomeric silicon compound in the mixture contributes less than 70% to the total silicon content.

In contrast to the known methods in which an initial substance is used that normally consists of a single and defined silicon compound which is as pure as possible, the present invention suggests the use of a mixture of several silicon compounds, with the proviso that one of the silicon compounds should be one containing a singular Si atom (hereinafter called “monomeric silicon compound” or “monomer” for short) and that another one of the silicon compounds should be one containing several Si atoms (hereinafter called oligomeric silicon compound or “oligomer” for short).

In the oligomeric silicon compound two or more silicon atoms are bonded to each other via one or several oxygen bridges. A typical example thereof are siloxanes.

Depending on the number of the silicon atoms in the silicon compound, these “oligomers” will hereinafter also specifically be called “dimers” in the case of two silicon atoms and “trimers” in the case of three silicon atoms.

When start material is used in the form of a monomeric silicon compound, a silica glass is obtained that shows high radiation resistance to short-wave UV laser radiation. This is particularly manifested by a high transmission of the silica glass, a low saturation level of the induced absorption and hardly any proneness to compaction or decompaction at the laser-radiation energy densities which are typical of microlithography.

By contrast, it has been found that synthetic silica glass which has been produced by using an oligomer, particularly an oligomer having a high amount of ring structures, shows increased defect formation vis-á-vis short-wave UV laser radiation. Therefore, this silica glass quality shows a comparatively low radiation resistance especially at the laser-radiation energy densities typical of microlithography, which is particularly manifested by a higher saturation level of the induced absorption. Moreover, it has been found that in such a silica glass the so-called “homogenization”, in which a glass item is repeatedly twisted in different directions, requires more efforts than in a silica glass produced by using SiCl₄.

These observations suggest that the structure of the SiO₂ network obtained during glass production depends on the initial substance used. A possible explanation for this could be that because of the close vicinity of the silicon atoms in an oligomer a comparatively large part of the SiO₂ primary particles formed during oxidation or hydrolysis is composed of two or more silicon atoms, said SiO₂ primary particles growing in the reaction zone into larger SiO₂ particles, e.g. by coagulation or condensation.

By contrast, the SiO₂ particles in a monomeric silicon compound (e.g. alkoxysilanes, alkylsilanes, SiCl₄) are formed by oxidation or hydrolysis of individual molecules, each containing only one silicon atom. Hence, it must be assumed that a large part of the SiO₂ primary particles initially formed in the reaction zone contain only one silicon atom.

During agglomeration into larger SiO₂ particles the SiO₂ primary particles formed in this way show a behavior differing from that of the SiO₂ primary particles produced from oligomers. In oligomeric silicon compounds, depending on their stoichiometry, more dimeric or oligomeric SiO₂ primary particles are present than during the conversion of monomeric silicon compounds. Depending on the number and configuration of the silicon atoms in the initial substances, the size of the primary particles and thus also the size of the resulting SiO₂ particles and the concentration thereof in the reaction zone will change. Moreover, this parameter also has an effect on the temperature within the reaction zone and thus on the whole deposition process in such a way that in an oligomer a network structure is obtained that shows the above-mentioned drawbacks with respect to radiation resistance.

On the other hand it is known that a higher deposition rate is achieved in the deposition process using an oligomeric silicon compound. The production method is thus more economic, which is even promoted by the fact that the oligomeric silicon compound based on the silicon content is less expensive than a monomeric silicon compound.

Surprisingly, it has now been found that the use of an initial substance in the form of a mixture containing at least one monomeric silicon compound and at least one oligomeric silicon compound can yield a silica glass having a radiation resistance comparable to that of a silica glass produced from a monomeric silicon compound. A precondition is however that the silicon amount deriving from the oligomeric silicon compounds in the mixture accounts for less than 70% of the total silicon content of the mixture.

Mixing of the different silicon compounds can basically be performed at any process stage. Mixing in the liquid phase presupposes that there are no reactions between the components that impair vaporization or reaction in the reaction zone.

This is e.g. often the case with mixtures of chlorine-containing and chlorine-free silicon compounds when polymerization reactions take place. Due to these observations mixing is preferably carried out in the gas phase and, if possible, at a late process stage, so that at least two vaporizer systems are needed as a rule. It is also possible that the silicon compounds are not intermixed before the reaction zone in that they are separately supplied to the reaction zone.

It is thereby possible to produce a silica glass in the case of which the efficiency of the production method is improved due to the use of oligomeric silicon compounds, and whose homogenizability and radiation resistance (with respect to its induced absorption and its behavior with respect to compaction and decompaction) do not substantially differ, despite the use of oligomeric silicon compounds, from a silica glass produced from monomeric silicon compounds.

It has turned out to be advantageous when the oligomeric silicon compound in the mixture contributes less than 60% to the total silicon content.

The smaller the amount deriving from the oligomeric silicon compound is in the total silicon demand, the better will be the resulting silica glass with respect to its homogenizability and radiation resistance. A contribution of less than 60% to the total silicon content has turned out be a particularly helpful compromise between radiation resistance and homogenizability of the silica glass on the one hand and the efficiency of the method on the other hand.

However, when the amounts of the oligomeric silicon compound are very small, its contribution to an enhanced efficiency of the method will no longer be noticed. Therefore, the oligomeric silicon compound in the mixture preferably contributes at least 30% to the total silicon content.

Due to their efficiency ring-like oligomers are preferably used. The use of an oligomeric silicon compound in the form of a polyalkylsiloxane has turned out to be particularly advantageous.

Polysiloxanes are characterized by a particularly high amount of silicon per weight, which contributes to the efficiency of the method. For instance, the weight portion of silicon in (octamethylcyclotetrasiloxane) OMCTS and in (decamethylcyclopentasiloxane) DMCPS is 37.9% each time, and in hexamethyidisiloxane it is 34.6%.

For this reason, and because of its large-scale availability together with a high purity, the polyalkylsiloxane which is preferably used in the method of the invention is an octamethylcyclotetrasiloxane (OMCTS) or a decamethylcyclopentasiloxane (DMCPS).

Alternatively, it has also turned out to be advantageous when a chlorine-free alkoxysilane is used as the monomeric silicon compound.

Alkoxysilanes are also characterized by large-scale availability and high purity. The absence of chlorine may have an advantageous effect on radiation resistance.

With respect thereto the use of an alkoxysilane in the form of methyltrimethoxysilane (MTMS) or a tetramethoxysilane (TMS) is particularly preferred.

The use of MTMS for silica glass production has the additional advantage that it is hardly toxic.

As for its large-scale availability and purity, silicon tetrachloride (SiCl₄) is advantageously used as the monomeric silicon compound.

As for the radiation resistance of the silica glass, a procedure has turned out to be particularly advantageous in which a mixture is used in which the ratio of the mixing amounts of MTMS and OMCTS is in the range of 40:60 to 60:40, preferably around 45:55 (based on the molecular silicon amount).

The mixing ratio refers to the respective amounts of the substances in the gas phase in which the substances are present in vaporized form. For setting a mixing ratio of 45:55 a gravimetric mixing ratio of MTMS to OMCTS of about 1.5:1 must be set.

In another procedure using SiCl₄ as the monomeric silicon compound, it has turned out to be useful when a mixture is employed in which the ratio of the mixing amounts of SiCl₄ and OMCTS, based on the molecular silicon amount, is between 30:70 and 70:30.

In a silica glass which is exclusively produced by using SiCl₄, a chlorine content ranging from 60 wt ppm to 130 wt ppm is normally measured. Due to mixing of a chlorine-free component (such as OMCTS) and the chlorine-containing component SiCl₄ a chlorine content of less than 60 wt ppm, but of more than about 10 ppm, can be adjusted in the silica glass in an easy way.

It has been found that in such a silica glass the damage mechanisms leading to compaction and decompaction are avoided or at least reduced considerably. Changes in the refractive index in the course of the intended use of components made from silica glass are avoided either completely or to a large degree, so that the said damage mechanisms do not limit the service of the optical components made from the silica glass.

Preferably, a chlorine-free silicon compound is used as the oligomeric silicon compound.

Hence, even if a chlorine-containing monomeric silicon compound is used in the mixture, a silica glass can be produced that has a low chlorine content and turns out to be superior particularly with respect to the damage patterns known as compaction/decompaction.

The silicon compounds can basically be mixed in a liquid phase or in a gaseous phase. However, a procedure is preferred in which the silicon compounds are vaporized separated from each other, the mixture being produced before or during method step b), e.g. before the gas stream is fed into the reaction zone.

This pre-mixing ensures a defined composition of the gas stream during introduction into the reaction zone and thus a reproducible and defined reaction sequence.

The present invention shall now be explained in more detail with reference to embodiments. As the sole figure,

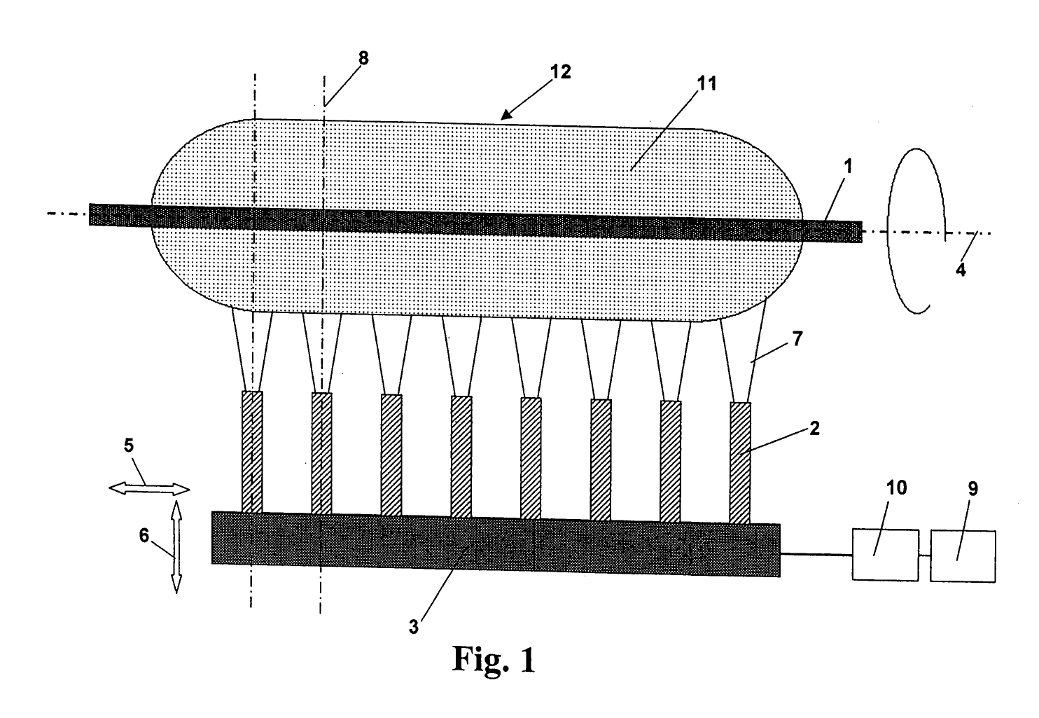

FIG. 1 shows a variant of the method according to the invention for producing an SiO₂ soot body.

In the apparatus shown in FIG. 1, there is provided a support tube 1 consisting of aluminum oxide, along which several series-arranged flame hydrolysis burners 2 are arranged. The flame hydrolysis burners 2 are mounted on a joint burner block 3 which can be reciprocated in parallel with the longitudinal axis 4 of the support tube 1 and is displaceable in a direction perpendicular thereto, as outlined by directional arrows 5 and 6. The burners consist of silica glass; their distance from one another is 15 cm.

Each of the flame hydrolysis burners 2 has assigned thereto a burner flame 7 having a main propagation direction 8 perpendicular to the longitudinal axis 4 of the support tube 1. A control device 9 which is connected to a drive 10 for the burner block 3 is provided for controlling the movement of the burner block 3.

With the help of the flame hydrolysis burners 2, SiO₂ particles are deposited on the support tube 1 which is rotating about its longitudinal axis 4, so that the blank 11 is built up in layers. To this end the burner block 5 is reciprocated along the longitudinal axis 4 of the support tube 1 between two reversal points that are stationary relative to the longitudinal axis 4. The amplitude of the reciprocating movement is marked by directional arrow 5. It is 15 cm, thus corresponding to the axial distance between the burners 2. In the deposition process a temperature of about 1200° C. is accomplished on a surface 12 of the blank.

The flame hydrolysis burners 2 are each supplied with oxygen and hydrogen as burner gases and with a gaseous mixture of chlorine-free initial substances as the initial material for the formation of SiO₂ particles.

After the deposition process has been completed, a soot tube is obtained that is subjected to a dehydration treatment and is vitrified so as to form a silica glass tube. A round rod which is free from striae in three dimensions and has a diameter of 80 mm and a length of about 800 mm is produced from the silica glass tube by repeated twisting at temperatures of about 2000° C. in different directions (homogenization). The behavior of the silica glass during homogenization is recorded each time.

Using heat deformation at a temperature of 1700° C. and a nitrogen-flushed melt mold, a circular silica glass block is formed therefrom with an outer diameter of 300 mm and a length of 90 mm.

For eliminating stress birefringence the silica glass block obtained in this way is subsequently subjected to a standard annealing treatment as described in EP-A1 401 845. To this end the silica glass block is heated, inter alia in air and at atmospheric pressure, to 1100° C. and is subsequently cooled at a cooling rate of 1° C./h. A stress birefringence of not more than 2 nm/cm is measured. The mean OH content is about 900 wt ppm. The silica glass block produced in this way is immediately suited as a blank for producing an optical lens for a microlithography device. For measuring the damage behavior of the silica class cylindrical measurement samples are cut having the dimensions 10 mm×10 mm×40 mm, and each of their four long sides is polished. For determining the radiation resistance the measurement samples are each irradiated by an UV excimer laser (wavelength=193 nm, pulse energy=100 mJ/cm², pulse repetition rate=200 Hz), the transmission being simultaneously measured at a wavelength λ=193 nm. Moreover, the behavior of the silica glass with respect to its compaction and decompaction behavior was determined, as described in “C. K. Van Peski, R. Morton and Z. Bor (“Behaviour of fused silica irradiated by low level 193 nm excimer laser for tens of billions of pulses”, J. Non-Cryst. Solids 265 (2000) pp. 285-289).

Table 1 shows the homogenizability and radiation resistance determined on the produced silica glass for different initial substances and mixing ratios, and it indicates the efficiency of the respective manufacturing method in terms of quality.

TABLE 1

| | | | | | Radiation | Radiation | |
|---|---|---|---|---|---|---|---|
| | Monomeric | Oligomeric | | | resistance | resistance | |
| | Si | Si | Mixing | Homo- | (induced | (compac./ | |
| No. | compound | compound | ratio | genizability | absorption | decompac. | Efficiency |
| 1 | SiCl₄ | — | — | ++ | ++ | + | 0 |
| 2 | MTMS | OMCTS | 45:55 | ++ | ++ | ++ | + |
| 3 | MTMS | HDMS | 45:55 | + | ++ | ++ | + |
| 4 | SiCl₄ | OMCTS | 45:55 | ++ | ++ | ++ | + |
| 5 | MTMS | OMCTS | 25:75 | − | 0 | | ++ |

In the table,
MTMS stands for methyltrimethoxysilane,
OMCTS stands for octamethylcyclotetrasiloxane,
HDMS stands for hexamethylcyclotetrasiloxane.

The figures of the mixing ratios of the samples designate the amount deriving from the respective substances in the total silicon content of the silica glass. For instance, in sample no. 1 the silicon amount derived from MTMS covers 45% of the total silicon demand and the silicon from the OMCTS contributes 55% thereto.

The qualitative results in Table 1 show that the use of an initial substance in the form of a mixture containing a monomeric silicon compound and an oligomeric silicon compound yields a silica glass in an economic way that has a radiation resistance comparable with a silica glass produced from a monomeric silicon compound. With an increasing amount of the oligomeric silicon compound in the mixture, the efficiency of the silica-glass production process increases and radiation resistance and homogenizability of the silica glass decrease. If the Si amount of the silica glass derives from the oligomeric silicon compound at not more than 70%, radiation resistance and homogenizability are adequate after all.

A similar result is obtained when instead of the soot method the silica glass is produced by direct vitrification.

1. A method for producing synthetic silica glass, said method comprising the steps of:
forming a gas stream containing a vaporizable initial substance which can be converted into SiO₂ by means of oxidation or flame hydrolysis,
supplying the gas stream to a reaction zone in which the initial substance is converted so as to form amorphous SiO₂ particles,
depositing the amorphous SiO₂ particles on a support so as to form an SiO₂ layer,
vitrifying the SiO₂ layer either during or following deposition of the SiO₂ particles to obtain the silica glass, wherein
the initial substance comprises a mixture of a monomeric silicon compound containing no more than one Si atom per molecule thereof and of an oligomeric silicon compound containing a plurality of Si atoms in each molecule thereof the silicon in the oligomeric silicon compound in the mixture constituting less than 70% of a total silicon content of the initial substance.

2. The method according to claim 1, wherein the silicon in the oligomeric silicon compound in the mixture constitutes less than 60% to the total silicon content.

3. The method according to claim 1, wherein the silicon in the oligomeric silicon compound in the mixture constitutes at least 30% to the total silicon content.

4. The method according claim 1, wherein the oligomeric silicon compound is a polyalkylsiloxane.

5. The method according to claim 4, wherein the polyalkylsiloxane is an octamethylcyclotetrasiloxane (OMCTS) or a decamethylcyclopentasiloxane (DMCPS).

6. The method according to claim 1, wherein the monomeric silicon compound is a chlorine-free alkoxysilane.

7. The method according to claim 6, wherein the alkoxysilane is methyltrimethoxysilane (MTMS) or a tetramethoxysilane (TMS).

8. The method according to claim 1, wherein the monomeric silicon compound is silicon tetrachloride (SiCl₄).

9. The method according to claim 1, wherein the oligomeric silicon compound is an octamethylcyclotetrasiloxane (OMCTS) and the monomeric silicon compound is methyltrimethoxysilane (MTMS);
the mixture having MTMS and OMCTS therein in respective mixing amounts such that a ratio of the mixing amounts of MTMS and OMCTS, based on a molecular silicon amount thereof, is in the range of 40:60 to 60:40.

10. The method according to claim 1, wherein the oligomeric silicon compound is an octamethylcyclotetrasiloxane (OMCTS) and the monomeric silicon compound is silicon tetrachloride (SiCl₄); and
the mixture having SiCl₄ and OMCTS therein in respective mixing amounts such that a ratio of the mixing amounts of SiCl₄ and OMCTS, based on a molecular silicon amount thereof, is between 30:70 and 70:30.

11. The method according to claim 1, wherein the oligomeric silicon compound is a chlorine-free silicon compound.

12. The method according to claim 1, wherein the silicon compounds are vaporized separated from each other and that the mixture is produced before or during the step of supplying the gas stream to the reaction zone.

13. The method according to claim 9, wherein the ratio of the mixing amounts of MTMS and OMCTS is approximately 45:55.
